(19) United States
(12) Patent Application Publication
(10) Pub. No.: US 2006/0187796 A1
(43) Pub. Date: Aug. 24, 2006

(54) Method of manufacturing an optical device and an optical device thereof

(76) Inventors: Yoshinori Shibahara, Nagano (JP); Fusayoshi Aruga, Nagano (JP)

Correspondence Address: CANTOR COLBURN, LLP, 55 GRIFFIN ROAD SOUTH, BLOOMFIELD, CT, 06002, US

(21) Appl. No.: 11/334,998

(22) Filed: Jan. 18, 2006

(30) Foreign Application Priority Data
Jan. 25, 2005 (JP) 2005-017354

(51) Int. Cl. G11B 7/00; G11B 7/135

(52) U.S. Cl. 369/112.01; 720/689

(57) ABSTRACT

To provide a method of manufacturing an optical device, and an optical device thereof, with which a current sensitivity, at the time when a movable side member is driven by energizing a drive coil, may be adjusted and/or optimized easily.

### CROSS REFERENCE TO RELATED APPLICATIONS

The present invention claims priority under 35 U.S.C. §119 to Japanese Application No. 2005-017354 filed Jan. 25, 2005, which is incorporated herein by reference.

### FIELD OF THE INVENTION

The present invention may relate to a method of manufacturing an optical device, and an optical device thereof; such as an optical head device to be used for playback of an optical recording medium and so on, e.g., a CD, a DVD, etc.; an optical waveguide switching device to be used for an optical fiber switching unit; an optical switching unit such as a variable optical attenuator to attenuate optical input as required; and so on.

### BACKGROUND OF THE INVENTION

In an optical device, such as an optical head device to be used for playback of an optical recording medium and so on, e.g., a CD, a DVD, etc., an optical waveguide switching device to be used for an optical fiber switching unit, an optical switching unit such as a variable optical attenuator to attenuate optical input as required and so on; it is required to drive an optical element to a prescribed position, and eventually there is constructed a magnetic drive mechanism, in which a movable side member equipped with an optical unit is mounted onto a stationary side member so as to become movable. The movable side member is driven by a drive coil and a drive magnet while the former is positioned at one member of the movable side member and the stationary side member, and the latter is positioned at the other member so as to face the drive coil.

On this occasion, a relative distance between the drive coil and the drive magnet greatly affects a current sensitivity at the time when the movable side member is driven by energizing the drive coil. However, due to a variation of manufacturing accuracy of each part as well as assembling accuracy, conventionally it is needed to have a spare distance of approximately 0.3 mm to 0.4 mm between the drive coil and the drive magnet so that it becomes impossible to narrow the relative distance between the drive coil and the drive magnet.

Then, it is proposed for manufacturing an optical head that a plurality of spacers, each of which has a different thickness, are prepared and a spacer having a most suitable thickness among the plurality of spacers is selected to be placed between a bottom side of the drive magnet and a yoke of the stationary side member in order to narrow the relative distance between the drive coil and the drive magnet. (For example, refer to Japanese Unexamined Patent Publication (Kokai) No. 2001-184693.

### SUMMARY OF THE INVENTION

However, there exists a problem that it is greatly time-consuming work to prepare a plurality of spacers, each of which has a different thickness, and select a spacer having a most suitable thickness among the plurality of spacers and place the spacer between a bottom side of the drive magnet and a yoke of the stationary side member as described in Japanese Unexamined Patent Publication (Kokai) No. 2001-184693, and eventually productivity gets worsened.

Furthermore; although a technique described in Japanese Unexamined Patent Publication (Kokai) No. 2001-184693 aims at narrowing the relative distance between the drive coil and the drive magnet; sometimes in practice there is a case where the current sensitivity, at the time when the movable side member is driven by energizing the drive coil, is so high that it is desired to lower the current sensitivity. However, there is a problem that the technique described in Patent Document 1 is not able to cope with the case mentioned above.

In view of the problems described above, a challenge is to provide a method of manufacturing an optical device, and an optical device thereof, with which a current sensitivity, at the time when a movable side member is driven by energizing a drive coil, can be optimized easily.

To solve the problems identified above, a method of manufacturing an optical device may be provided; the device may be equipped with a movable side member having an optical element, a stationary side member to support the movable side member so as to enable movement of the movable side member, a drive coil positioned at one member of the movable side member and the stationary side member, a drive magnet positioned at the other member of the movable side member and the stationary side member so as to face the drive coil, and provided with a magnetic drive means to drive the movable side member; comprises: a preparation of a plurality of spacers, each of which has the same thickness; an assembly process, in which the drive coil is placed onto the one member described above, and on the other hand the drive magnet is placed onto the other member described above; a sensitivity inspection process, in which a current sensitivity is inspected under a condition where the drive coil is energized to drive the movable side member; and a sensitivity correction process, in which a required number of the spacers are layered at, according to a measure result of the current sensitivity, at least either of positions, i.e., a position on a top side of the drive magnet facing the drive coil, and another position between a bottom side, i.e., a counter side to the top side, of the drive magnet and the stationary side member.

In an embodiment of the present invention; a plurality of spacers, each of which has the same thickness, are prepared; in the sensitivity inspection process the current sensitivity is inspected under a condition where the drive coil is energized to drive the movable side member; and according to the inspection result, in the sensitivity correction process a required number of the spacers are layered at the position on the top side of the drive magnet facing the drive coil, and the position between the bottom side, i.e., the counter side to the top side, of the drive magnet and the stationary side member. Consequently, according to the present invention, it becomes unnecessary to prepare multiple kinds of spacers as well as to select a most suitable spacer so that adjustment of the current sensitivity does not take a lot of time. Furthermore, spacers are placed at the top side of the drive magnet facing the drive coil according to the inspection result of the current sensitivity, and therefore it is also possible to lower the current sensitivity.

In another embodiment of the present invention; a method of manufacturing an optical device; which is equipped with a movable side member having an optical element, a stationary side member to support the movable side member so as to enable movement of the movable side member, a drive coil positioned at one member of the movable side member and the stationary side member, a drive magnet positioned at the other member of the movable side member and the stationary side member so as to face the drive coil, and provided with a magnetic drive means to drive the movable side member; may comprise: placement of a first drive magnet and the second drive magnet, as the drive magnet, at both sides so as to sandwich the drive coil; placement of a first drive coil facing the first drive magnet, and a second drive coil facing the second drive magnet, to drive the movable side member in a direction, being different from a direction that the first drive coil aims at, as the drive coil between the first drive magnet and the second drive magnet. On this occasion, a plurality of spacers, each of which has the same thickness, are prepared and the method of manufacturing further comprises; an assembly process, in which the first drive coil and the second drive coil are placed onto the one member described above, and on the other hand the first drive magnet and the second drive magnet are placed onto the other member described above; a sensitivity inspection process, in which a current sensitivity is inspected under a condition where the drive coils are energized to drive the movable side member; and a sensitivity correction process, in which a required number of the spacers are layered at, according to a measure result of the current sensitivity, at least one of positions; i.e., a position on a top side of the first drive magnet facing the first drive coil; another position between a bottom side, i.e., a counter side to the top side, of the first drive magnet and the stationary side member; another position on a top side of the second drive magnet facing the second drive coil; and still another position between a bottom side, i.e., a counter side to the top side, of the second drive magnet and the stationary side member.

Thus, when the other member described above is equipped with a yoke facing the drive coil, the drive magnet is mounted on a side of the yoke facing the drive coil in the assembly process.

In an embodiment of the present invention; a spacer made of at least one of a magnetic material and a non-magnetic material is layered, as the spacer described above, between the bottom side of the drive magnet and the stationary side member in the sensitivity correction process, in order to raise the current sensitivity. Furthermore, it is also possible that a spacer made of a magnetic material is layered, as the spacer described above, at the top side of the drive magnet in the sensitivity correction process, in order to lower the current sensitivity.

In an embodiment of the present invention; an optical device comprises: a movable side member having an optical element; a stationary side member to support the movable side member so as to enable movement of the movable side member; a drive coil positioned at one member of the movable side member and the stationary side member; a drive magnet positioned at the other member of the movable side member and the stationary side member so as to face the drive coil; and a magnetic drive means to drive the movable side member; wherein, at a bottom side of the drive magnet that is a counter side to a top side of the drive magnet facing the drive coil, a plurality of spacers are layered between the bottom side of the drive magnet and the stationary side member.

In another embodiment of the present invention; an optical device comprises: a movable side member having an optical element; a stationary side member to support the movable side member so as to enable movement of the movable side member; a drive coil positioned at one member of the movable side member and the stationary side member; a drive magnet positioned at the other member of the movable side member and the stationary side member so as to face the drive coil; and a magnetic drive means to drive the movable side member; wherein, at a top side of the drive magnet facing the drive coil, at least one spacer is placed.

On this occasion, it is also possible to adopt a configuration, in which a plurality of the spacers, each of which has the same thickness, are layered at the top side of the drive magnet facing the drive coil.

In still another embodiment of the present invention; an optical device comprises: a movable side member having an optical element; a stationary side member to support the movable side member so as to enable movement of the movable side member; a drive coil positioned at one member of the movable side member and the stationary side member; a drive magnet positioned at the other member of the movable side member and the stationary side member so as to face the drive coil; and a magnetic drive means to drive the movable side member; wherein a first drive magnet and the second drive magnet are placed, as the drive magnet, at both sides so as to sandwich the drive coil; a first drive coil facing the first drive magnet, and a second drive coil facing the second drive magnet, to drive the movable side member in a direction, being different from a direction that the first drive coil aims at, are placed, as the drive coil, between the first drive magnet and the second drive magnet; a spacer is layered at, at least one of positions; i.e., a position on a top side of the first drive magnet facing the first drive coil; another position between a bottom side, i.e., a counter side to the top side, of the first drive magnet and the stationary side member; another position on a top side of the second drive magnet facing the second drive coil; and still another position between a bottom side, i.e., a counter side to the top side, of the second drive magnet and the stationary side member; and at least in either of relationships; between the top side of the first drive magnet and the top side of the second drive magnet, and between the bottom side of the first drive magnet and the bottom side of the second drive magnet; the numbers of the spacers are different each other.

In an embodiment of the present invention; if a spacer made of at least one of a magnetic material and a non-magnetic material, as the spacer described above, is placed at the bottom side of the drive magnet, it becomes possible to raise the current sensitivity in comparison with a case where no spacer is used.

In an embodiment of the present invention; if a spacer made of a magnetic material as the spacer described above is placed at the top side of the drive magnet, it becomes possible to lower the current sensitivity in comparison with a case where no spacer is used.

In an embodiment of the present invention; when the other member described above is equipped with a yoke facing the drive coil, it is offered to mount the drive magnet on a side of the yoke facing the drive coil.

In an embodiment of the present invention; the spacer is fixed, for example, onto a side of the drive magnet with an adhesive. On this occasion, it is preferable that plane size of the spacer is the same as plane size of the drive magnet.

An optical device relating to the present invention may be constructed as an optical head device to be used for playback of an optical recording medium and so on, e.g., a CD, a DVD, etc.; an optical waveguide switching device to be used for an optical fiber switching unit; an optical switching unit such as a variable optical attenuator to attenuate optical input as required; and so on.

In an optical device and a method of manufacturing an optical device of an embodiment the present invention; a plurality of spacers, each of which has the same thickness, are prepared; in the sensitivity inspection process the current sensitivity is inspected under a condition where the drive coil is energized to drive the movable side member; and according to the inspection result, in the sensitivity correction process a required number of the spacers are layered at the position on the top side of the drive magnet facing the drive coil, and the position between the bottom side, i.e., the counter side to the top side, of the drive magnet and the stationary side member. Consequently, according to an embodiment of the present invention, it becomes unnecessary to prepare multiple kinds of spacers as well as to select a most suitable spacer so that adjustment of the current sensitivity does not take a lot of time. Furthermore, in an embodiment of the present invention the spacers are placed at the top side of the drive magnet facing the drive coil according to the inspection result of the current sensitivity, and therefore it is also possible to lower the current sensitivity.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1A and FIG. 1B are perspective view drawings that show views of diagonally looking down and looking up an optical device (an optical head device), respectively, relating to a preferred embodiment 1 of the present invention.

FIG. 2A and FIG. 2B are a plane view and a perspective view of a magnetic drive circuit section being partially pulled out, respectively, for a focusing drive and a tracking drive of the optical head device shown in FIG. 1.

FIG. 3 is an explanatory drawing to schematically show a principle of an optical device (an optical waveguide switching device) relating to a preferred embodiment 2 of the present invention.

FIG. 4 is a perspective view drawing that shows a view of looking at the optical waveguide switching device, for which the principle shown in FIG. 3 is applied, diagonally from a rear side.

FIG. 5 is a perspective view drawing that shows a view of looking at a key section of the optical waveguide switching device shown in FIG. 4 diagonally from a front side.

FIG. 6 is an explanatory drawing of a magnetic drive circuit structured into the optical waveguide switching device that FIG. 4 shows.

FIG. 7 is a graph that shows current sensitivities in a case where spacers are used in the magnetic drive circuit shown in FIG. 6.

### DESCRIPTION OF THE PREFERRED EMBODIMENTS

An optical head device and an optical switching unit as optical devices, for which the present invention is applied, are described below with reference to the accompanying drawings.

### Preferred Embodiment 1

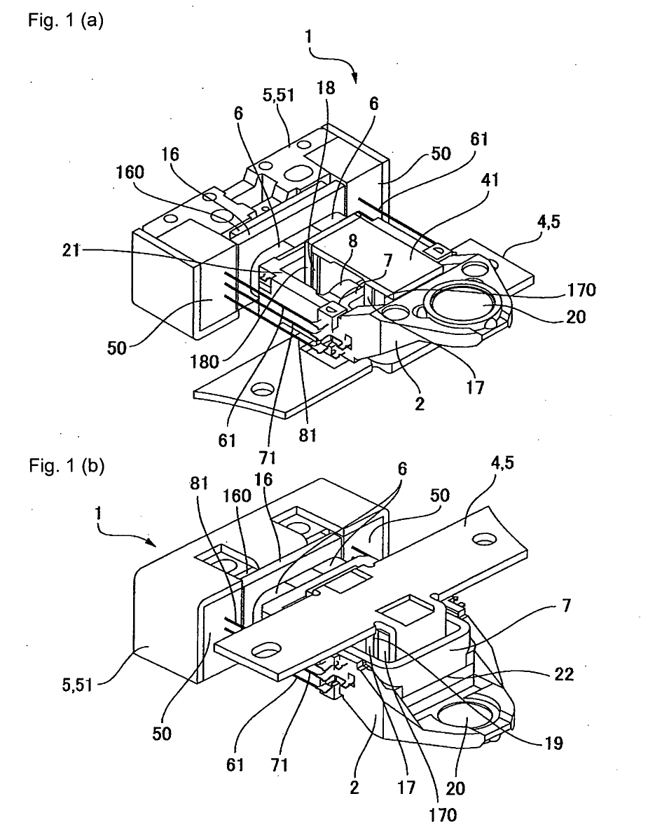

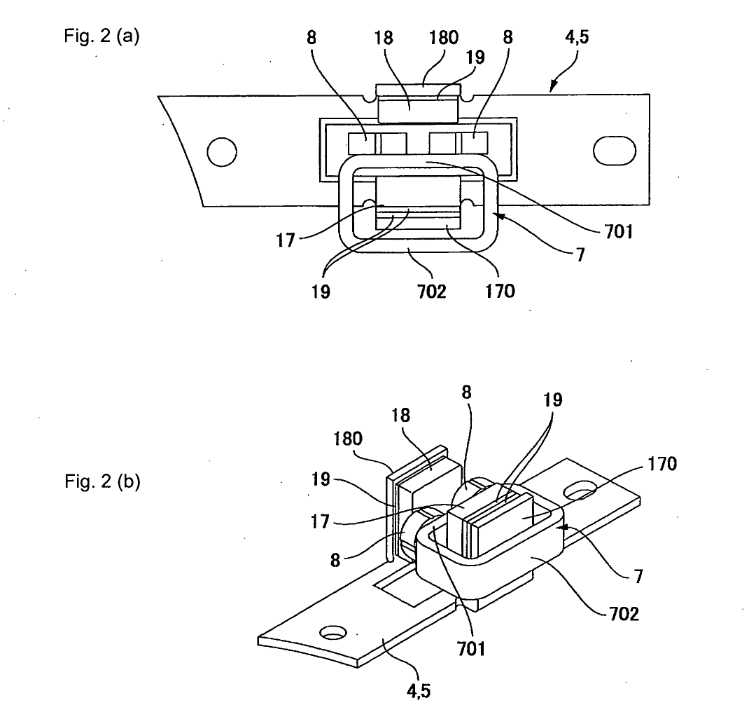

FIG. 1A and FIG. 1B are perspective view drawings that show views of diagonally looking down and looking up an optical head device (an optical device) for which the present invention is applied, respectively. FIG. 2A and FIG. 2B are a plane view and a perspective view of a magnetic drive circuit section being partially pulled out, respectively, for a focusing drive and a tracking drive of an optical head device, for which the present invention may be applied.

An optical head device 1, shown in FIG. 1A and FIG. 1B, is used for playback of an optical recording medium and so on, such as a CD, a DVD, etc. In the optical head device 1, a wireless suspension method is applied so that a resin-made lens holder 2 (a movable side member) holding an object lens 20 (an optical element), which converges light beams launched from a light source onto an optical recording medium, is supported by a wire 61, another wire 71, and still another wire 81 onto a stationary side member 5. That is to say, between the lens holder 2 and the stationary side member 5, there are placed; the wire 61, which is a bilaterally-coupled wire for a tilt drive and also works as a coil power supply cable for driving the lens holder 2 in a tilt direction; the wire 71, which is a bilaterally-coupled wire for a focusing drive and also works as a coil power supply cable for driving the lens holder 2 in a focusing direction; and the wire 81, which is a bilaterally-coupled wire for a tracking drive and also works as a coil power supply cable for driving the lens holder 2 in a tracking direction.

The wire 61 for a tilt drive, the wire 71 for a focusing drive, and the wire for a tracking drive are placed in this order from a top level to a bottom level, and the three wires are laid out in the same position plane-wise to overlap each other. Furthermore, all of the wire 61 for a tilt drive, the wire 71 for a focusing drive, and the wire 81 for a tracking drive have their wire's tip ends connected to both the right and left sides of the lens holder 2, and have their wire's root ends connected to the stationary side member 5. The stationary side member 5 is composed of a base part 51, on which a circuit board (not illustrated on the drawing) is mounted, and a yoke 4; and then, the base part 51 is provided with a gel-pot 50 for the wire 61 for a tilt drive, the wire 71 for a focusing drive, and the wire 81 for a tracking drive.

In the optical head device 1 of the present embodiment; a magnetic drive circuit is constructed with a coil 6, another coil 7, and still another coil 8 that are mounted onto a side of the lens holder 2, as well as a magnet 16, another magnet 17, and still another magnet 18 that are directly or indirectly mounted onto each corresponding part of the yoke 4 as a base, for the purpose of driving the lens holder 2 in the focusing direction, the tracking direction, and the tilt direction. That is to say; the lens holder 2 is equipped with the coil 6 for a tilt drive, the coil 8 (the second drive coil) for a tracking drive, and the coil 7 (the first drive coil) for a focusing drive; which are assembled in this order from a side of the stationary side member 5 toward a tip side. Then, incidentally the coil 6, the coil 7, and the coil 8 are all hollow coils.

Among these coils, the coil 6 for a tilt drive is placed onto the lens holder 2 at a position facing the base part 51. Therefore, on the base part 51, the magnet 16 for a tilt drive is placed at a position facing the lens holder 2. Incidentally, the magnet 16 for a tilt drive is supported by the stationary side member 5 by means of a yoke 160.

On the other hand, the coil 8 for a tracking drive is placed at a first opening part 21 formed at a center position in a widthwise direction of the lens holder 2. Meanwhile, the coil 7 for a focusing drive is placed inside a second opening part 22 that is adjacent to the first opening part 21 at a side where the object lens 20 is mounted, while having an opening part of the coil 7 oriented vertically.

As FIG. 1A, FIG. 1B, FIG. 2A, and FIG. 2B show; inside the first opening part 21 of the lens holder 2, a yoke 180 protrudes from a side of the yoke 4 (the stationary side member 5) toward an inside of the coil 8 for a tracking drive. Meanwhile, the magnet 18 for a tracking drive (the second drive magnet), which is magnetized to have separated poles in a direction from the right to left, is fixed to a side end of the yoke 180. In such a manner, the magnet 18 for a tracking drive is placed so as to face the coil 8 for a tracking drive.

Furthermore, inside the second opening part 22 of the lens holder 2, a yoke 170 protrudes from a side of the yoke 4 (the stationary side member 5) toward an inside of the coil 7 for a focusing drive. Meanwhile, the magnet 17 for a focusing drive (the first drive magnet), which is magnetized to have separated poles in a vertical direction, is fixed to a side end, being opposite to where object lens 20 is positioned, of the yoke 170. In such a manner, the magnet 17 for a focusing drive is placed so as to face the coil 7 for a focusing drive. As a result, in the coil 7 for a focusing drive, a part directly facing the magnet 17 for a focusing drive works as an effective side 701, while a part directly facing the yoke 170 becomes an ineffective side 702. By the way, the yoke 4 is equipped with an upper section 41, which covers the lens holder 2 while passing through the first opening part 21 of the lens holder 2 and is made of a magnetic material and magnetically connected to the yoke 4.

In such a manner according to the present embodiment; between the magnet 18 for a tracking drive (the second drive magnet) and the magnet 17 for a focusing drive (the first drive magnet), the coil 8 for a tracking drive (the second drive coil) faces the magnet 18, and meanwhile the coil 7 for a focusing drive (the first drive coil) faces the magnet 17.

Furthermore in the present embodiment; as FIG. 2A and FIG. 2B illustrate for example, one spacer 19 is placed between a rear side surface of the magnet 18 and the yoke 180, and meanwhile two spacers 19 are placed between a rear side surface of the magnet 17 and the yoke 170. On this occasion, the spacer 19 placed between the rear side surface of the magnet 18 and the yoke 180 has the same thickness as the spacers 19 placed between the rear side surface of the magnet 17 and the yoke 170, and for example these spacers are SPCC plates that are approximately 50 microns in thickness. Furthermore, all these spacers are layered with an adhesive onto the magnet 17, the magnet 18, the yoke 170, or the yoke 180. Moreover, plane size of these spacers 19 is the same as plane size of the magnet 17 and the magnet 18.

(Method of Manufacturing)

To manufacture the optical head device 1 provided with a structure as described above; in the present embodiment, a plurality of spacers 19 having the same thickness are prepared. Then, in the assembly process, the coil 7 and the coil 8 are placed at a side of the lens holder 2 while the magnet 17 and the magnet 18 are placed onto the yoke 170 and the yoke 180, respectively.

Next, in the sensitivity inspection process; a current sensitivity is inspected under a condition, for example, in which the coil 7 and the coil 8 are energized to drive the lens holder 2.

Next, in the sensitivity correction process; according to a measure result of the current sensitivity in the sensitivity inspection process, a required number of the spacers 19 are layered at, at least either of positions; i.e., a position on top sides of the magnet 17 and the magnet 18 facing the coil 7 and the coil 8, respectively; and another position between bottom sides, i.e., counter sides to the top sides, of the magnet 17 and the magnet 18 and the yoke 170 and the yoke 180, respectively. Namely, in the case of the optical head device 1; a position of the lens holder 2 is usually detected by sensor and the detection result is fed back, and then the current sensitivity is set up within an adequate range from the viewpoint of vibration.

In the example shown by FIG. 2A and FIG. 2B, one spacer 19 is placed between the rear side surface of the magnet 18 and the yoke 180, and meanwhile two spacers 19 are placed between the rear side surface of the magnet 17 and the yoke 170. Incidentally, if it is required in the sensitivity correction process to raise the current sensitivity, a required number of spacers 19 made of either a magnetic material or a non-magnetic material are layered at each position between the bottom sides of the magnet 17 and the magnet 18 and the yoke 170 and the yoke 180, respectively. On the other hand, if it is required to lower the current sensitivity, a required number of spacers 19 made of a magnetic material are layered at each position on top sides of the magnet 17 and the magnet 18. By the way, the upper section 41 of the yoke 4, made of a magnetic material, forms a closed magnetic circuit while being magnetically connected to the yoke 4 itself. Incidentally, if the spacers 19 made of a magnetic material are inserted at each position on top sides of the magnet 17 and the magnet 18, a magnetic flux of the spacers 19 passes through the upper section 41 so that there is eventually obtained an effect that the current sensitivity becomes lowered even in the case of insertion of the spacers 19 made of a magnetic material.

Therefore, in the present embodiment;

| On top side | Between the | On top side | Between the |
|---|---|---|---|
| of the magnet | magnet 17 | of the magnet | magnet 18 |
| 17 | and the yoke | 18 | and the yoke |
| | 170 | | 180 |

[Average Values of Displacement]

| | | | | | Calculation |
|---|---|---|---|---|---|
| | −15 μm | +20 μm | −20 μm | +25 μm | values |
| E.g. 1 | 0 pc(s). | 0 pc(s). | 0 pc(s). | 1 pc(s). | +25 μm |
| E.g. 2 | 0 pc(s). | 0 pc(s). | 0 pc(s). | 2 pc(s). | +50 μm |
| E.g. 3 | 0 pc(s). | 1 pc(s). | 0 pc(s). | 0 pc(s). | +20 μm |
| E.g. 4 | 0 pc(s). | 2 pc(s). | 0 pc(s). | 0 pc(s). | +40 μm |
| E.g. 5 | 0 pc(s). | 1 pc(s). | 0 pc(s). | 1 pc(s). | +45 μm |
| E.g. 6 | 0 pc(s). | 2 pc(s). | 0 pc(s). | 2 pc(s). | +90 μm |
| E.g. 7 | 0 pc(s). | 1 pc(s). | 0 pc(s). | 2 pc(s). | +70 μm |
| E.g. 8 | 0 pc(s). | 2 pc(s). | 0 pc(s). | 1 pc(s). | +65 μm |
| E.g. 9 | 0 pc(s). | 0 pc(s). | 1 pc(s). | 0 pc(s). | −20 μm |
| E.g. 10 | 0 pc(s). | 0 pc(s). | 2 pc(s). | 0 pc(s). | −40 μm |
| E.g. 11 | 1 pc(s). | 0 pc(s). | 0 pc(s). | 0 pc(s). | −15 μm |
| E.g. 12 | 2 pc(s). | 0 pc(s). | 0 pc(s). | 0 pc(s). | −30 μm |
| E.g. 13 | 1 pc(s). | 0 pc(s). | 1 pc(s). | 0 pc(s). | −35 μm |
| E.g. 14 | 2 pc(s). | 0 pc(s). | 2 pc(s). | 0 pc(s). | −70 μm |
| E.g. 15 | 1 pc(s). | 0 pc(s). | 2 pc(s). | 0 pc(s). | −55 μm |
| E.g. 16 | 2 pc(s). | 0 pc(s). | 1 pc(s). | 0 pc(s). | −50 μm |

if a number of spacers 19 corresponding to a required displacement value is selected out of the example above, for example according to a measure result of the current sensitivity so as to have a stable displacement point within a specification range of ±25 microns and the spacers are layered at each required position, the optical head device 1 having an optimum current sensitivity can be constructed.

(Principal Effect of the Present Embodiment)

Thus, in the present embodiment; a plurality of spacers 19, each of which has the same thickness, are prepared; in the sensitivity inspection process the current sensitivity is inspected under a condition where the coil 7 and the coil 8 are energized to drive the lens holder 2; and according to the inspection result, in the sensitivity correction process a required number of the spacers 19 are layered at each position on the top sides of the magnet 17 and the magnet 18 facing the coil 7 and the coil 8, respectively, and each position between the bottom sides, i.e., the counter sides to the top sides, of the magnet 17 and the magnet 18 and the yoke 170 and the yoke 180, respectively. Consequently, according to the present invention, it becomes unnecessary to prepare multiple kinds of spacers as well as to select a most suitable spacer so that adjustment of the current sensitivity does not take a lot of time under a condition of driving in the focusing direction and the tracking direction. Furthermore, in the present invention the spacers 19 are placed at each position of the top sides of the magnet 17 and the magnet 18 facing the coil 7 and the coil 8, respectively, according to the inspection result of the current sensitivity in the sensitivity inspection process, and therefore it is also possible to lower the current sensitivity.

Incidentally, although the present invention is applied to an optical head device equipped with 3 wires, i.e., the wire 61, the wire 71, and the wire 81 for a tilt drive, a focusing drive, and a tracking drive, respectively; it is also possible to apply the present invention to an optical head device equipped with 2 wires or other configuration.

### Preferred Embodiment 2

(Principle)

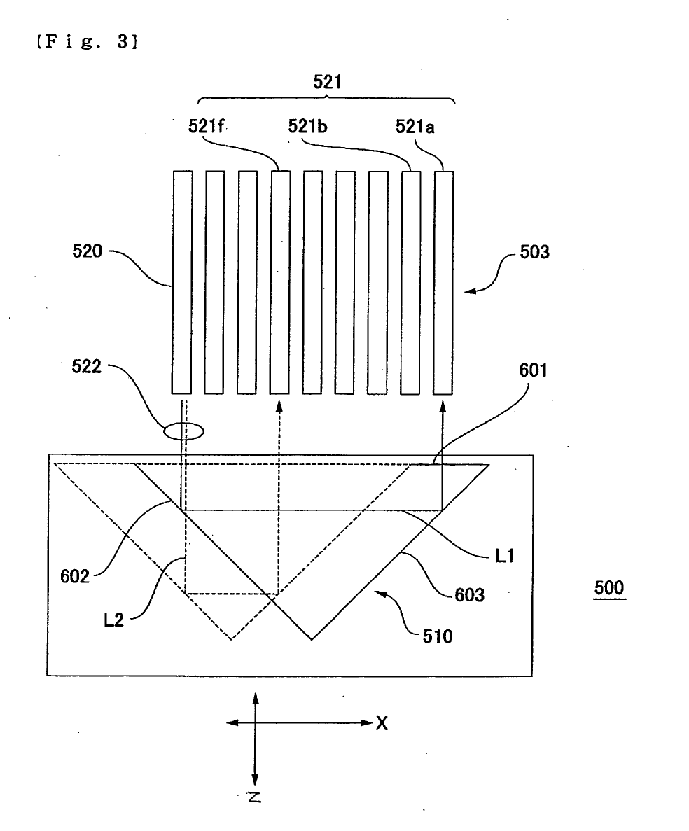

FIG. 3 is an explanatory drawing to schematically show a basic principle of an optical device (an optical waveguide switching device/an optical switching unit) relating to a preferred embodiment 2 of the present invention. Incidentally in the following explanation, three directions that lie at right angles one another are called ‘X-direction’, ‘Y-direction’ and ‘Z-direction for the explanation.

In FIG. 3, an optical waveguide switching device 500 (an optical switching unit) of the present embodiment is an 8-channel optical waveguide switching device, in which an input side optical fiber 520 stretching in the Z-direction as well as 8 output side optical fibers 521 are arranged in parallel while being lined up in the X-direction, and the optical waveguide switching device is able to guide a light beam output from the input side optical fiber 520 into one of the 8 output side optical fibers 521. On this occasion, in an optical fiber array 503 composed of the input side optical fiber 520 and the output side optical fibers 521, the optical fibers are arranged so as to be uniformly spaced at intervals of 125 microns in the X-direction.

In the optical waveguide switching device 500 of the present embodiment, a prism mirror 510 (an optical element) to be driven in the X-direction is used as a light reflecting member to reflect a light beam, which has been entered from the Z-direction, and to launch the light beam in the Z-direction from a specified position that is displaced in the X-direction. The prism mirror 510 is a right-angled prism equipped with a slope 601 where a light beam gets entered and launched in the Z-direction; a first reflecting surface 602 to reflect the light beam, which has been entered through the slope 601, in the X-direction; and a second reflecting surface 603, which lies at right angles to the first reflecting surface 602 and reflects the light beam, coming from the first reflecting surface 602 after being reflected there, toward the slope 601; and the slope 601 (a side of the opening) faces the optical fiber array 503 right in the front. Then, a light beam launched from the input side optical fiber 520 is treated by a collimating lens 522 before getting entered into the prism mirror 510 so as to become a collimated light beam. Furthermore, another collimating lens is also placed between the 8 output side optical fibers 521 and the slope 601 of the prism mirror 510, although it is not illustrated on the drawing.

In the optical waveguide switching device 500 structured as described above, it is assumed that the prism mirror 510 is fixed at a position indicated by the solid line for example. Under the condition, a light beam launched from the input side optical fiber 520 gets entered into the prism mirror 510, and then the light beam passes through a light path L1, in which the light beam is reflected at a 90-degree angle at each surface of the first reflecting surface 602 and the second reflecting surface 603 inside the prism mirror 510, and eventually the light beam is guided into an output side optical fiber 521a positioned at the right end of the output side optical fibers 521.

Next, when the optical waveguide of the output side is switched from the output side optical fiber 521a to an output side optical fiber 521f, being placed at a 6th position from the right end; the prism mirror 510 is driven in the X-direction so as to be located at a position that the dotted line indicates. When the prism mirror 510 is shifted in such a manner, each of reflecting positions at the first reflecting surface 602 and the second reflecting surface 603 inside the prism mirror 510 is shifted so that the light beam launched from the input side optical fiber 520 passes through a light path L2 and eventually the light beam is guided into the output side optical fiber 521f.

On this occasion, in the optical fiber array 503; the input side optical fiber 520 and the output side optical fibers 521 are laid out so as to be spaced at intervals of 125 microns. Therefore, the prism mirror 510 is shifted in the X-direction in steps of 125 microns that corresponds to the space intervals of the output side optical fibers 521.

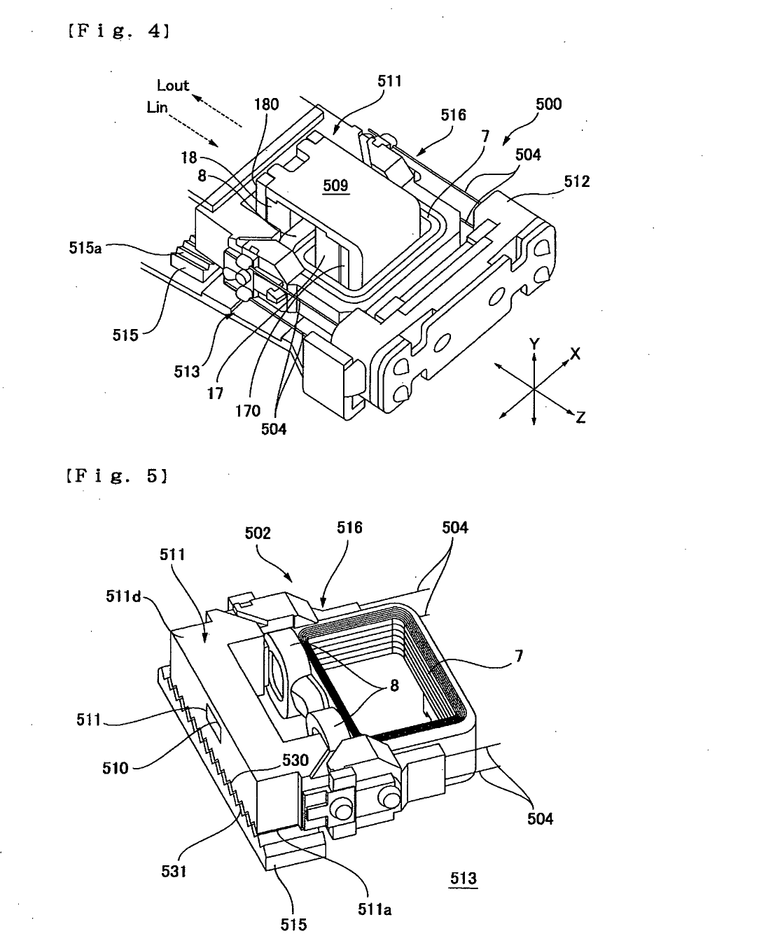

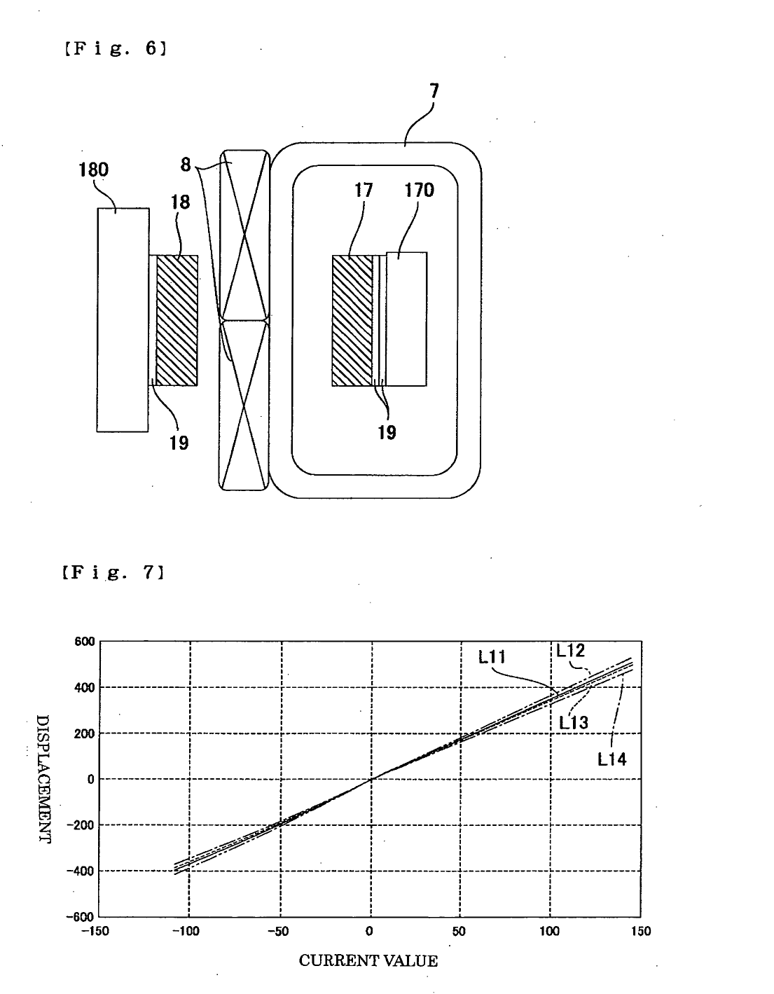

FIG. 4 and FIG. 5 are perspective view drawings that show views of looking at a key section of an optical waveguide switching device of the present invention diagonally from a rear side and a front side, respectively. On the other hand, FIG. 6 is an explanatory drawing of a magnetic drive circuit structured into the optical waveguide switching device that FIG. 4 shows. The optical waveguide switching device 500, to which the operation principle described above by making reference to FIG. 3 is applied, has the slope 601 faced in the Z-direction, as FIG. 4 and FIG. 5 show for example. Then, the optical waveguide switching device is equipped with a movable side member 502, on which the prism mirror 510 is mounted, and a stationary side member 513 that supports the movable side member 502 in such a manner that the movable side member 502 can be shifted in the X-direction and the Y-direction.

In addition to the prism mirror 510, a coil 7 (a first drive coil) for driving in the Y-direction and a bilaterally-coupled coil 8 (a second drive coil) for driving in the X-direction are mounted on the movable side member 502. On the other hand, the stationary side member 513 is equipped with a magnet 17 (a first drive magnet) for driving in the Y-direction and a magnet 18 (a second drive magnet) for driving in the X-direction, while the magnet 17 being located inside the coil 7. Then, the magnet 18 is faced to the coil 8. On this occasion, in the stationary side member 513; two yokes, i.e., a yoke 170 and another yoke 180, are erected so as to face the coil 7 and the coil 8, respectively. Then, on a surface where the yoke 170 out of the two yokes is across from the coil 7 and the coil 8, the magnet 17 is mounted. Meanwhile, on a surface where the yoke 180 is across from the coil 7 and the coil 8, the magnet 18 is mounted. Moreover; a yoke 509, which covers a higher area of the magnet 17 and the magnet 18, is also mounted.

From a supporting member 512 of the stationary side member 513, each two suspension wires 504 are stretched horizontally on the right hand side and left hand side in order to support the movable side member 502 while sandwiching the movable side member from both the sides in the X-direction and cantilevering it. By the way, a control circuit (not illustrated on the drawing) for the coil 7 and the coil 8, which are mounted on the movable side member 502, is placed on a side of the supporting member 512. Then, power supply to the coil 7 and the coil 8, which are mounted on the movable side member 502, is implemented by using the suspension wires 504 as power supply lines.

The magnet 17 generates flux that twines the coil 7 mounted on the movable side member 502, and makes up a magnetic drive circuit in combination with the coil 7 to drive the movable side member 502 in the Y-direction. Therefore, supplying the coil 7 with electric power provides the movable side member 502 with a thrust in the Y-direction. Furthermore, the magnet 18 generates flux that twines the coil 8 mounted on the movable side member 502, and makes up a magnetic drive circuit in combination with the coil 8 to drive the movable side member 502 in the X-direction. Therefore, supplying the coil 8 with electric power provides the movable side member 502 with a thrust in the X-direction.

The movable side member 502 is composed of a prism mirror mounting section 511, at the front part of which a prism mirror 510 is mounted, and a frame section 516, on which the coil 7 and the coil 8 are mounted. Then, in a further front area away from the prism mirror mounting section 511, the optical fiber array 503 already explained by making reference to FIG. 3 is located. In FIG. 4 and FIG. 5, each optical axis of a launched light beam out of the input side optical fiber 520 of the optical fiber array 503 and a launched light beam to the output side optical fibers 521 of the optical fiber array 503 is indicated as an optical axis ‘Lin’ and ‘Lout’, respectively.

In the optical waveguide switching device 500 structured as described above; at a Z-direction side of the movable side member 502, a clamping mechanism (not illustrated) is constructed for the purpose of fixing the movable side member 502 by pressing the movable side member 502 down to the stationary side member 513 in the Y-direction at a required timing.

Furthermore in the present embodiment; in the movable side member 502, a bottom side section 511a of the prism mirror mounting section 511 facing the stationary side member 513 is equipped with V-shaped grooves 530 formed in series at certain intervals in a full extent of the X-direction. In other words, a concave part V-shaped in section and a convex part V-shaped in section are formed alternately in the bottom side section of the movable side member 502. In the present embodiment; since a layout pitch in the optical fiber array 503 is 125 microns, a layout pitch of the V-shaped grooves 530 is accordingly set to be 125 microns.

On the other hand, in the stationary side member 513; a fixing part 515, which is longer in the X-direction than the bottom side section 511a, is formed at a position facing the bottom side section 511a of the prism mirror mounting section 511 of the movable side member 502. Then, at a top side section 515a of the fixing part 515, V-shaped grooves 531 to gear with the V-shaped grooves 530 (concave parts & convex parts) formed at the bottom side section 511a of the movable side member 502 are formed in series. In other words, a concave part V-shaped in section and a convex part V-shaped in section are formed alternately in the stationary side member 513. A layout pitch of the V-shaped grooves 531 is also set to be 125 microns.

On this occasion, a moving path of the movable side member 502 in the X-direction, the bottom side section 511a of the prism mirror mounting section 511, and the top side section 515a of the fixing part 515 formed in the stationary side member 513 are arranged in parallel one another.

In the optical waveguide switching device 500 structured as described above; at a fixed position in an initial stage, the movable side member 502 is pressed against the stationary side member 513 by the clamping mechanism and fixed there, and then the V-shaped grooves 530 and the V-shaped grooves 531 located at an upper side position and a lower side position, respectively, are geared with each other.

In order to carry out operation of switching an optical waveguide under such a condition, the status of being clamped by the clamping mechanism is canceled. Then, the coil 7 is supplied with electric power to lift up the movable side member 502 in the Y-direction so as to make the movable side member 502 float away from the stationary side member 513.

Next, the coil 8 is supplied with electric power to move the movable side member 502 in the X-direction. Then, at the time when the movable side member 502 arrives at a required position in the X-direction, the electric power supply to the coil 7 is stopped or the movable side member 502 is driven downward so that the movable side member 502 goes down in the Y-direction by elastic restoring force of the suspension wires 504.

Next, the movable side member 502 is pressed down in the Y-direction to the stationary side member 513 and fixed there by the clamping mechanism. At the time, the V-shaped grooves 530 formed in the movable side member 502 and the V-shaped grooves 531 formed in the stationary side member 513 are geared with each other, and eventually a location of the movable side member 502 in the X-direction is fixed.

Then, after the steps described above, the electric power supply to the drive coil 8 is stopped. Thus, the operation of switching an optical waveguide is completed. Consequently; a light beam, which has been entered from the input side optical fiber 520 into the prism mirror 510, is launched through the prism mirror 510 to one of the output side optical fibers 521 as required.

Also in the optical waveguide switching device 500 structured as described above; between the magnet 18 (the second drive magnet) and the magnet 17 (the first drive magnet), the coil 8 (the second drive coil) faces the magnet 18, and meanwhile the coil 7 (the first drive coil) faces the magnet 17, as shown in FIG. 6.

Furthermore in the present embodiment; as FIG. 6 illustrates for example, one spacer 19 is placed between a rear side surface of the magnet 18 and the yoke 180, and meanwhile two spacers 19 are placed between a rear side surface of the magnet 17 and the yoke 170. The spacer 19 placed between the rear side surface of the magnet 18 and the yoke 180 has the same thickness as the spacers 19 placed between the rear side surface of the magnet 17 and the yoke 170, and for example these spacers are SPCC plates that are approximately 50 microns in thickness. Furthermore, all these spacers are layered with an adhesive onto the magnet 17, the magnet 18, the yoke 170, or the yoke 180. Moreover, plane size of these spacers 19 is the same as plane size of the magnet 17 and the magnet 18.

(Method of Manufacturing)

FIG. 7 is a graph that shows current sensitivities in a case where spacers are used in a magnetic drive circuit shown in FIG. 6. Incidentally, in the graph of current sensitivities that FIG. 7 shows, the horizontal axis corresponds to current values, while the vertical axis shows shift distance values of the movable side member in the X-direction.

To manufacture the optical waveguide switching device 500 of the present embodiment; in the present embodiment, a plurality of spacers 19 having the same thickness are prepared. Then, in the assembly process, the coil 7 and the coil 8 are placed at a side of the movable side member 502 while the magnet 17 and the magnet 18 are placed onto the yoke 170 and the yoke 180, respectively.

Next, in the sensitivity inspection process; a current sensitivity is inspected under a condition, for example, in which the coil 7 and the coil 8 are energized to drive the movable side member 502 in the X-direction.

Next, in the sensitivity correction process; according to a measure result of the current sensitivity in the sensitivity inspection process, a required number of the spacers 19 are layered at, at least either of positions; i.e., a position on top sides of the magnet 17 and the magnet 18 facing the coil 7 and the coil 8, respectively; and another position between bottom sides, i.e., counter sides to the top sides, of the magnet 17 and the magnet 18 and the yoke 170 and the yoke 180, respectively. Namely, in the case of the optical waveguide switching device 500; neither position detection nor feedback control is carried out in shift operation in the X-direction, and furthermore a shift distance is long; therefore the current sensitivity itself directly defines performance of the optical waveguide switching device 500.

In the example shown by FIG. 6, one spacer 19 is placed between the rear side surface of the magnet 18 and the yoke 180, and meanwhile two spacers 19 are placed between the rear side surface of the magnet 17 and the yoke 170. Incidentally, if it is required in the sensitivity correction process to raise the current sensitivity, a required number of spacers 19 made of either a magnetic material or a non-magnetic material are layered at each position between the bottom sides of the magnet 17 and the magnet 18 and the yoke 170 and the yoke 180, respectively. On the other hand, if it is required to lower the current sensitivity, a required number of spacers 19 made of a magnetic material are layered at each position on top sides of the magnet 17 and the magnet 18.

For example, a current sensitivity in the case of using no spacer 19 is indicated with the solid line ‘L11’ in FIG. 7. Meanwhile, if one spacer 19 is layered between the magnet 17 and the yoke 170, the current sensitivity is raised as the two-dot chain line ‘L12’ shows in FIG. 7. To the contrary, if one spacer 19 is layered on the top side of the magnet 18, the current sensitivity is lowered as the dotted line ‘L13’ shows in FIG. 7. If one spacer 19 is layered on the top side of the magnet 17, the current sensitivity is lowered as the one-dot chain line ‘L14’ shows in FIG. 7. Incidentally, if the spacers 19 made of a magnetic material are inserted at each position on top sides of the magnet 17 and the magnet 18, a magnetic flux of the spacers 19 passes through the yoke 509 located at an upper area so that there is eventually obtained an effect that the current sensitivity becomes lowered even in the case of insertion of the spacers 19 made of a magnetic material.

Therefore, in the present embodiment;

| On top side | Between the | On top side | Between the |
|---|---|---|---|
| of the magnet | magnet 17 | of the magnet | magnet 18 |
| 17 | and the yoke | 18 | and the yoke |
| | 170 | | 180 |

[Average Values of Displacement]

| | | | | | Calculation |
|---|---|---|---|---|---|
| | −15 μm | +20 μm | −20 μm | +25 μm | values |
| E.g. 1 | 0 pc(s). | 0 pc(s). | 0 pc(s). | 1 pc(s). | +25 μm |
| E.g. 2 | 0 pc(s). | 0 pc(s). | 0 pc(s). | 2 pc(s). | +50 μm |
| E.g. 3 | 0 pc(s). | 1 pc(s). | 0 pc(s). | 0 pc(s). | +20 μm |
| E.g. 4 | 0 pc(s). | 2 pc(s). | 0 pc(s). | 0 pc(s). | +40 μm |
| E.g. 5 | 0 pc(s). | 1 pc(s). | 0 pc(s). | 1 pc(s). | +45 μm |
| E.g. 6 | 0 pc(s). | 2 pc(s). | 0 pc(s). | 2 pc(s). | +90 μm |
| E.g. 7 | 0 pc(s). | 1 pc(s). | 0 pc(s). | 2 pc(s). | +70 μm |
| E.g. 8 | 0 pc(s). | 2 pc(s). | 0 pc(s). | 1 pc(s). | +65 μm |
| E.g. 9 | 0 pc(s). | 0 pc(s). | 1 pc(s). | 0 pc(s). | −20 μm |
| E.g. 10 | 0 pc(s). | 0 pc(s). | 2 pc(s). | 0 pc(s). | −40 μm |
| E.g. 11 | 1 pc(s). | 0 pc(s). | 0 pc(s). | 0 pc(s). | −15 μm |
| E.g. 12 | 2 pc(s). | 0 pc(s). | 0 pc(s). | 0 pc(s). | −30 μm |
| E.g. 13 | 1 pc(s). | 0 pc(s). | 1 pc(s). | 0 pc(s). | −35 μm |
| E.g. 14 | 2 pc(s). | 0 pc(s). | 2 pc(s). | 0 pc(s). | −70 μm |
| E.g. 15 | 1 pc(s). | 0 pc(s). | 2 pc(s). | 0 pc(s). | −55 μm |
| E.g. 16 | 2 pc(s). | 0 pc(s). | 1 pc(s). | 0 pc(s). | −50 μm |

if a number of spacers 19 corresponding to a required displacement value is selected out of the example above, for example according to a measure result of the current sensitivity so as to have a stable displacement point within a specification range of ±25 microns and the spacers are layered at each required position, the optical waveguide switching device 500 having an optimum current sensitivity can be constructed.

Thus, in the present embodiment; a plurality of spacers 19, each of which has the same thickness, are prepared; in the sensitivity inspection process the current sensitivity is inspected under a condition where the coil 7 and the coil 8 are energized to drive the lens holder 2; and according to the inspection result, in the sensitivity correction process a required number of the spacers 19 are layered at each position on the top sides of the magnet 17 and the magnet 18 facing the coil 7 and the coil 8, respectively, and each position between the bottom sides, i.e., the counter sides to the top sides, of the magnet 17 and the magnet 18 and the yoke 170 and the yoke 180, respectively. Consequently, according to the present invention, it becomes unnecessary to prepare multiple kinds of spacers as well as to select a most suitable spacer so that adjustment of the current sensitivity does not take a lot of time. Furthermore, in the present embodiment the spacers 19 are placed at each position of the top sides of the magnet 17 and the magnet 18 facing the coil 7 and the coil 8, respectively, according to the inspection result of the current sensitivity, and therefore it is also possible to lower the current sensitivity. Accordingly, in the case of the optical waveguide switching device 500; neither position detection nor feedback control is carried out in shift operation in the X-direction, and furthermore a shift distance is long; therefore the current sensitivity itself directly defines performance of the optical waveguide switching device 500. Under such circumstances, according to the present embodiment, it is possible to set the current sensitivity within an appropriate range, and therefore the performance of the optical waveguide switching device 500 can be greatly improved.

Although the present embodiment is an example where the present invention is applied to an optical waveguide switching device to be used for an optical fiber switching unit, it is also possible to apply the present invention to a variable optical attenuator to attenuate optical input as required.

What is claimed is:

1. A method of manufacturing an optical device which is equipped with a movable side member having an optical element, a stationary side member to support the movable side member so as to enable movement of the movable side member, a drive coil positioned at one member of the movable side member and the stationary side member, a drive magnet positioned at the other member of the movable side member and the stationary side member so as to face the drive coil, and provided with a magnetic drive means to drive the movable side member; the method comprising:
preparing a plurality of spacers that have a specified thickness;
an assembly process, in which the drive coil is placed onto the one member described above, and on the other hand the drive magnet is placed onto the other member described above;
a sensitivity inspection process, in which a current sensitivity is inspected under a condition where the drive coil is energized to drive the movable side member; and
a sensitivity correction process, in which a required number of the spacers are layered at, according to a measure result of the current sensitivity, at least either of the following positions, a position on a top side of the drive magnet facing the drive coil, or another position between a bottom side that is a counter side to the top side, of the drive magnet and the stationary side member.

2. The method of manufacturing an optical device according to claim 1:
wherein the other member described above is equipped with a yoke facing the drive coil; and
in the assembly process, the drive magnet is mounted on a side of the yoke facing the drive coil.

3. The method of manufacturing an optical device according to claim 1:
wherein a spacer made of at least one of a magnetic material and a non-magnetic material is layered, as the spacer described above, between the bottom side of the drive magnet and the stationary side member in the sensitivity correction process, in order to raise the current sensitivity.

4. The method of manufacturing an optical device according to claim 1:
wherein a spacer made of a magnetic material is layered, as the spacer described above, at the top side of the drive magnet in the sensitivity correction process, in order to lower the current sensitivity.

5. A method of manufacturing an optical device; which is equipped with a movable side member having an optical element, a stationary side member to support the movable side member so as to enable movement of the movable side member, a drive coil positioned at one member of the movable side member and the stationary side member, a drive magnet positioned at the other member of the movable side member and the stationary side member so as to face the drive coil, and provided with a magnetic drive means to drive the movable side member; the method comprising:
placing a first drive magnet and a second drive magnet, as the drive magnet, at both sides so as to sandwich the drive coil;
placing a first drive coil facing the first drive magnet, and a second drive coil facing the second drive magnet, to drive the movable side member in a direction, being different from a direction that the first drive coil aims at, as the drive coil between the first drive magnet and the second drive magnet;
preparing a plurality of spacers, each of which has the same thickness;
an assembly process, in which the first drive coil and the second drive coil are placed onto the one member described above, and on the other hand the first drive magnet and the second drive magnet are placed onto the other member described above;
a sensitivity inspection process, in which a current sensitivity is inspected under a condition where the drive coils are energized to drive the movable side member; and
a sensitivity correction process, in which a required number of the spacers are layered at, according to a measure result of the current sensitivity, at least one of positions; i.e., a position on a top side of the first drive magnet facing the first drive coil; another position between a bottom side, i.e., a counter side to the top side, of the first drive magnet and the stationary side member; another position on a top side of the second drive magnet facing the second drive coil; and still another position between a bottom side, i.e., a counter side to the top side, of the second drive magnet and the stationary side member.

6. The method of manufacturing an optical device according to claim 5:
wherein the other member described above is equipped with a yoke facing the drive coil; and
in the assembly process, the drive magnet is mounted on a side of the yoke facing the drive coil.

7. The method of manufacturing an optical device according to claim 5:
wherein a spacer made of at least one of a magnetic material and a non-magnetic material is layered, as the spacer described above, between the bottom side of the drive magnet and the stationary side member in the sensitivity correction process, in order to raise the current sensitivity.

8. The method of manufacturing an optical device according to claim 5:
wherein a spacer made of a magnetic material is layered, as the spacer described above, at the top side of the drive magnet in the sensitivity correction process, in order to lower the current sensitivity.

9. An optical device comprising:
a movable side member having an optical element;
a stationary side member to support the movable side member so as to enable movement of the movable side member;
a drive coil positioned at one member of the movable side member and the stationary side member;
a drive magnet positioned at the other member of the movable side member and the stationary side member so as to face the drive coil; and
a magnetic drive means to drive the movable side member;
wherein, at a bottom side of the drive magnet that is a counter side to a top side of the drive magnet facing the drive coil, a plurality of spacers are layered between the bottom side of the drive magnet and the stationary side member.

10. The optical device according to claim 9:
wherein, at the bottom side of the drive magnet, a spacer made of at least one of a magnetic material and a non-magnetic material is placed, as the spacer described above.

11. The optical device according to claim 9:
wherein, at the top side of the drive magnet, a spacer made of a magnetic material is placed, as the spacer described above.

12. The optical device according to claim 9:
wherein the other member described above is equipped with a yoke facing the drive coil; and
the drive magnet is mounted on a side of the yoke facing the drive coil.

13. An optical device comprising:
a movable side member having an optical element;
a stationary side member to support the movable side member so as to enable movement of the movable side member;
a drive coil positioned at one member of the movable side member and the stationary side member;
a drive magnet positioned at the other member of the movable side member and the stationary side member so as to face the drive coil; and
a magnetic drive means to drive the movable side member;
wherein, at a top side of the drive magnet facing the drive coil, at least one spacer is placed.

14. The optical device according to claim 13:
wherein, at the top side of the drive magnet facing the drive coil, a plurality of the spacers, each of which has the same thickness, are layered.

15. The optical device according to claim 13:
wherein, at the top side of the drive magnet, a spacer made of a magnetic material is placed, as the spacer described above.

16. The optical device according to claim 13:
wherein the other member described above is equipped with a yoke facing the drive coil; and
the drive magnet is mounted on a side of the yoke facing the drive coil.

17. An optical device comprising:
a movable side member having an optical element;
a stationary side member to support the movable side member so as to enable movement of the movable side member;
a drive coil positioned at one member of the movable side member and the stationary side member;
a drive magnet positioned at the other member of the movable side member and the stationary side member so as to face the drive coil; and
a magnetic drive means to drive the movable side member;
wherein a first drive magnet and a second drive magnet are placed, as the drive magnet, at both sides so as to sandwich the drive coil;
a first drive coil facing the first drive magnet, and a second drive coil facing the second drive magnet, to drive the movable side member in a direction, being different from a direction that the first drive coil aims at, are placed, as the drive coil, between the first drive magnet and the second drive magnet;
a spacer is layered at, at least one of the following positions; a position on a top side of the first drive magnet facing the first drive coil; another position between a bottom side, that is a counter side to the top side, of the first drive magnet and the stationary side member; another position on a top side of the second drive magnet facing the second drive coil; and still another position between a bottom side, that is a counter side to the top side, of the second drive magnet and the stationary side member; and
at least in either of relationships; between the top side of the first drive magnet and the top side of the second drive magnet, and between the bottom side of the first drive magnet and the bottom side of the second drive magnet; the numbers of the spacers are different each other.

18. The optical device according to claim 17:
wherein, at the bottom side of the drive magnet, a spacer made of at least one of a magnetic material and a non-magnetic material is placed, as the spacer described above.

19. The optical device according to claim 17:
wherein, at the top side of the drive magnet, a spacer made of a magnetic material is placed, as the spacer described above.

20. The optical device according to claim 17:
wherein the other member described above is equipped with a yoke facing the drive coil; and
the drive magnet is mounted on a side of the yoke facing the drive coil.
